(19) United States
(12) Patent Application Publication
(10) Pub. No.: US 2004/0149150 A1
(43) Pub. Date: Aug. 5, 2004

(54) Embossing apparatus

(76) Inventors: Michael P. Seifert, Hartland, WI (US); Bennett J. Skaletski, Ripon, WI (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/762,865

(22) Filed: Jan. 22, 2004

Related U.S. Application Data
(60) Provisional application No. 60/441,651, filed on Jan. 22, 2003.

(51) Int. Cl. B44B 5/00

(52) U.S. Cl. 101/3.1

(57) ABSTRACT

An embossing apparatus is comprised of a first embossing member that defines one or more embossing designs therein and a second embossing member that defines one or more embossing designs therein that substantially match the embossing designs of the first embossing member. The first and second embossing members are coupled together with one or more coupling elements to maintain said first and second embossing elements in planar alignment and align said embossing designs of the first and second embossing members.

### CROSS-REFERENCE TO RELATED APPLICATION

This is a non-provisional application claiming priority to U.S. provisional application Serial No. 60/441,651 filed Jan. 22, 2003.

### FIELD OF THE INVENTION

The present invention relates to an apparatus for embossing representations on media, and more particularly, to an improved embossing apparatus which is very inexpensive to manufacture, easy to assemble and operable to produce repeatable renderings.

### DESCRIPTION OF THE ART

Prior art embossing systems commonly available are bulky, expensive and difficult to work with for the amateur craft hobbyist. One conventional embossing system includes a base tray, two-ply stencil, and positioning pegs. The tray may be an injection molded or thermo formed plastic support surface having a working area bounded by a surround. The working area is recessed offset from the surround and has a plurality of positioning receptacles that are disposed about the outer edge thereof. Plurality of holding receptacles are formed in the surround. The positioning pegs are disposed in the surround receptacles prior to use of the system. In use, the two-ply stencil is fitted to the working area such that apertures about the exterior edge of the stencil aligned with the working area positioning receptacles. The media to be embossed is positioned between the plies of the stencil. The positioning pegs are removed from the surround receptacles and inserted through the apertures in the stencil into the working area positioning receptacles. Selected representations may then be transferred onto the media. Of course, such embossing systems are relatively expensive to manufacture and require several components to be employed during use.

One attempt in the art to simplify such stencil-type embossing devices is disclosed in U.S. Pat. No. 5,511,472 to Taylor. The Taylor reference teaches an embossing apparatus that includes a lower stencil and an upper stencil joined by a hinge along one side thereof that allows the upper stencil to overlay the lower stencil. The Taylor reference also discloses pegs permanently affixed to the lower stencil that fit through holes in the upper stencil, with the pegs and holes used to provide the same function as the hinge. In both examples, however, the hinge and or peg/hole arrangement may prevent embossing of a medium at a desired location as the medium cannot extend beyond the hinge or pegs when positioned between the upper and lower stencils.

Thus, it would be advantageous to provide an embossing apparatus that is easy and relatively inexpensive to manufacture. It would also be an advantage to provide an embossing apparatus that provides a means for alignment that does not interfere with the embossing process.

### SUMMARY OF THE INVENTION

Accordingly, an embossing apparatus is comprised of a pair of interconnected planar elements, that may be in the form of stencils or templates, hereinafter referred to as embossing members. Each embossing member is provided with various cutout patterns or designs that substantially matches the cutout patterns or designs of the other. When combined, the two embossing members form an embossing device that can be used to emboss a medium, such as paper, card stock, or other sheet-like materials, with a pattern or design provided by the embossing apparatus. The two embossing members are interconnected in a manner that allows the patterns or designs of the two embossing members to be properly aligned.

In one embodiment, two embossing members are interconnected with a tab and hole arrangement. That is, in one of the embossing members, a plurality of radially extending tabs are formed in a first embossing member. As the base of the tabs defines an effective radius, a properly placed hole is provided in a second embossing member. By flexing the tabs and inserting them into the hole in the second embossing member, a pivoting attachment is formed between the two embossing members. When one of the embossing members is rotated relative to the other, the patterns or designs formed therein can be readily aligned. Moreover, this attachment does not require any additional components to join the two embossing members while providing a secure engagement between the two embossing members.

In another embodiment, an embossing apparatus is formed from two circular embossing members that are interconnected at a center point. The two embossing members can be aligned relative to one another by aligning one or more recesses and/or protrusions along the perimeter edges of the embossing members.

In yet another embodiment, an embossing apparatus is comprised of a pair of rectangular-shaped embossing members that are coupled together proximate one or more corners thereof. The embossing members are coupled in a manner that allows the two embossing members to be easily separated at the point of coupling. By coupling the embossing members at more than one location, patterns or designs located proximate one point of coupling can be used to emboss a medium by decoupling the two embossing members at that location, while coupling at other locations properly align the embossing members.

In still another embodiment, an embossing apparatus is formed by coupling two embossing members together at one or more points. The two embossing members are coupled using one or more mechanical fasteners. The fasteners may include a rivet, a snap, or other such devices known in the art.

The principles of the present invention are applicable to structures used to emboss a design, representation or addition on a desired media and stencils, templates, models, figures, and interconnected planer elements and shall be described herein in connection with such pattern/template. However, it will be appreciated by those with skill in the art that the principles of the present invention are not so limited and can be applied to other structures for many different uses.

### BRIEF DESCRIPTION OF THE DRAWINGS

FIG. 1 is a top view of a first embodiment of an embossing apparatus in disassembled form in accordance with the principles of the present invention;

FIG. 2 is a top view of the embossing apparatus of FIG. 1 when assembled;

FIG. 3 is a top view of a second embodiment of an embossing apparatus in disassembled form in accordance with the principles of the present invention;

FIG. 4 is a top view of a third embodiment of an embossing apparatus in disassembled form in accordance with the principles of the present invention;

FIG. 5A is a partial top view detail of a fourth embodiment of an embossing apparatus in accordance with the principles of the present invention;

FIG. 5B is a partial side view detail of the embossing apparatus shown in FIG. 5A;

FIG. 6 is a partial top view detail of a fifth embodiment of an embossing apparatus in accordance with the principles of the present invention;

FIG. 7 is a partial top view detail of a sixth embodiment of an embossing apparatus in accordance with the principles of the present invention;

FIG. 8A is a partial top view detail of a seventh embodiment of an embossing apparatus in accordance with the principles of the present invention;

FIG. 8B is a partial side view detail of the embossing apparatus shown in FIG. 8A;

FIG. 9A is a partial top view detail of an eighth embodiment of an embossing apparatus in accordance with the principles of the present invention;

FIG. 9B is a partial side view detail of the embossing apparatus shown in FIG. 9A;

FIG. 10A is a partial top view detail of a ninth embodiment of an embossing apparatus in accordance with the principles of the present invention;

FIG. 10B is a partial side view detail of the embossing apparatus shown in FIG. 10A; and

FIG. 11 is a perspective view of a tenth embodiment of an embossing apparatus in use in accordance with the principles of the present invention.

### DETAILED DESCRIPTION

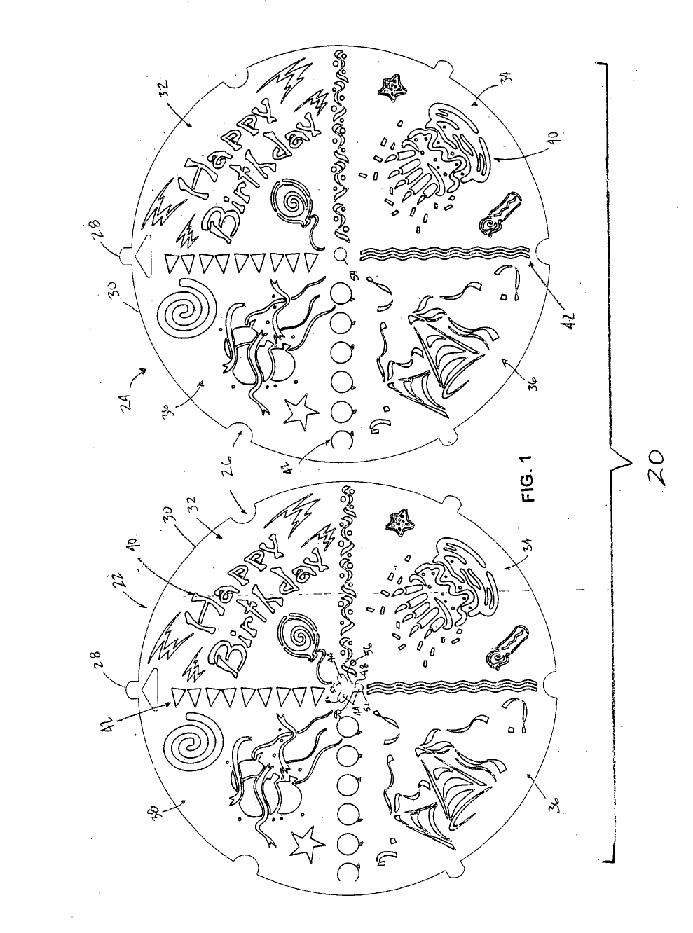

Turning now to the drawings where like numbers represent like components, FIG. 1 illustrates an embossing apparatus, generally indicated at 20, for creating an embossed rendering of designs and/or patterns contained therein onto an embossing medium, such as paper, card stock, or other materials known in the art to which embossing is desired in accordance with the principles of the present invention. As used hereafter, the term embossing member shall include but not be limited to any structure that can be used in accordance with the principles of the present invention including patterns and templates or other generally planar, sheet-like structures and the like. The embossing apparatus 20 includes a first embossing element 22 and a second embossing element 24, that when combined form the embossing apparatus 20 according to the present invention. It should be noted that reference to the embossing elements 22 and 24 is not to limit the form of such structures, but only that when combined result in a device that can be used for embossing a medium, when that medium is inserted between the embossing elements 22 and 24 Each of the first and second elements 22, 24 are preferably formed from a stiff, yet flexible material. This material may be at least partially transparent. Plastics and other synthetic materials have proven effective. For example, plastics used for forming drafting templates, stencils or other similar devices would be applicable. However, it is within the teachings of the present invention that metallic elements or elements from other materials may also be successfully used.

In this embodiment, the first and second embossing elements 22, 24 are generally circular in configuration. However, one of skill in the art will recognize that any shape may be used for the elements 22, 24 and the shape of the first and second elements may differ themselves if so desired. A series of alignment notches 26 and tabs 28 are formed about the perimeter edge 30 of each embossing element 22, 24. In use, the alignment notches 26 and tabs 28 visually and physically indicate proper orientation of the first embossing element 22 relative to the second embossing element 24 such that effective embossing of a media disposed between the first and second embossing elements 22, 24 may be accomplished.

As illustrated, the first element 22 includes first 32, second 34, third 36, and fourth 38 regions each having a plurality of slots 40 and divided representations 42 formed therein to define main designs or representations radially extending at 90 degree intervals so as to separate each region. It is within the teachings of the present invention that the main designs or representations may be disposed within any such region defined as desired and the divider representations may be disposed at any angle or may be eliminated as desired. Each of the first, second, third, and fourth regions 32, 34, 36, and 38 has a plurality of slots 40 formed therein to define a design, indicia or representation-for embossing on the media. It is within the teachings of the present invention that the first embossing element 22 may have as many or as few regions as desired and that the main designs or representations essentially define the scope of the regions. Additionally, each of the components of each of the main designs or representations may be configured for selective interchangeability such that multiple designs and representations may be reproduced as desired.

A plurality of guides, lugs or tabs 44 are defined near the center of the first element 22. In this embodiment, three guides are defined and arranged radially about a center point 46 of the first element 22. Each of the guides 44 has substantially the same structural configuration, which includes a base portion 48 and a head portion 50. The guides are defined by a slot or space 52 formed in the first element 22. It will be understood by those with skill in the art that the specific shape of the guide is not a determining factor as to function, but rather, in this embodiment, that the head portions 50 collectively are configured to pass through aperture 54 in the second element 24 and the base portion 48 is configured to engage the aperture 54 in the second element 24 as will be discussed below.

The guides 44 in this embodiment are configured as a parabola, a parabolic segment or D-shaped. Likewise these slots or spaces 52 generally represent a line-drawn outline of the parabola, parabolic segment or D-shaped. The spaces 52 extend between a first end 56 and a second end 58. The guides 44 are movably related to the first element 22 by a living hinge defined by a line which intersects the ends 56, 58 of the slot 52, and, accordingly may be oriented above the top surface of the first element 22 at an angle to the first element 22.

The second element 24 is configured generally identical to the first element 22 with the following exceptions noted hereafter. The slots formed in the second element 24 which define the main and divided designs, indicia and representations are physically larger. Generally, the degree of increased size required is minimal for the invention to function in accordance with the disclosure herein. An overall increase in the width dimension of the slots on the order of 15/1000 of an inch is acceptable. An increase in the width dimension of approximately 5/1000 of an inch to 50/1000 of an inch may be satisfactory. It is within the teachings of the present invention that the difference in the width dimension of the slots formed in the first element 22 compared to the second element 24 may be adjusted as desired to accommodate various different stylus embossing tools. The larger slots formed in the second element 24 function as a guide for the stylus embossing tool.

A central aperture 54 is formed in the second element 24. The guides engage the aperture 54 as described above to permit the second element 24 to be movable relative to the first element 22.

In operation, a user bends the guides 44 about the living hinge away from the plane of the first element 22 such that all of the guides 44 may simultaneously fit through the aperture 54 of the second element 24. The first and second elements 22, 24 are then disposed in a parallel, planar abutting relationship and are rotateably joined about the aperture 54 for relative angular movement. A user then inserts a desired media between the first and second elements 22, 24 and uses the alignment notches and tabs to correctly orient the first and second elements 22, 24 such that the media may then be embossed as desired. It is within the teachings of the present invention that the media may be any deformable material, such as, paper, cardboard, plastic, synthetic material, or metal.

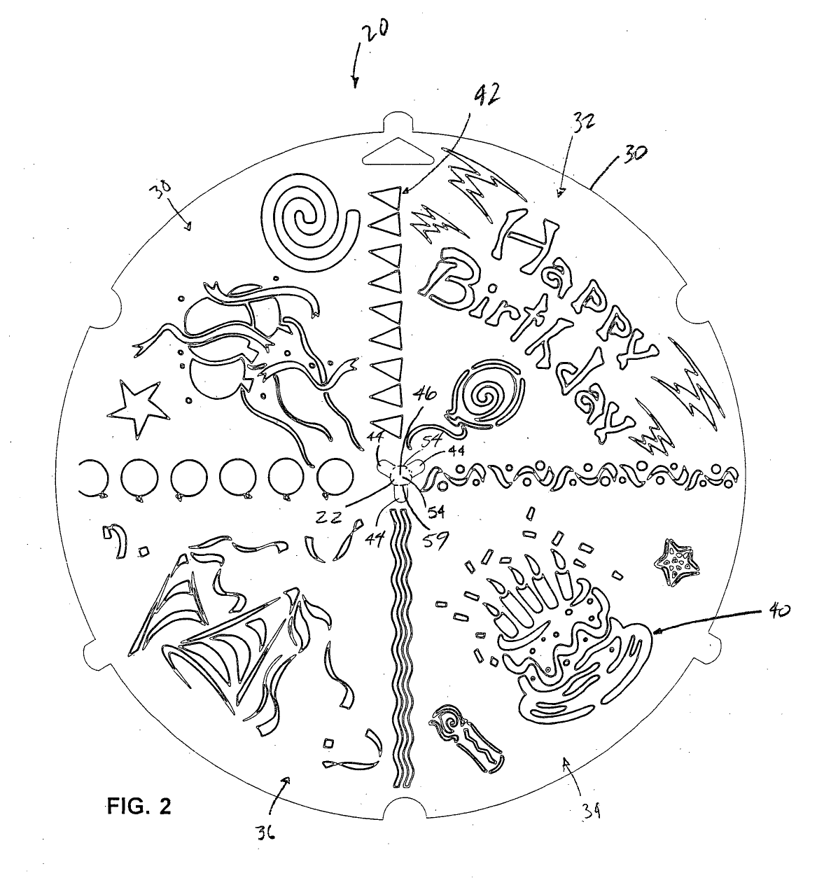

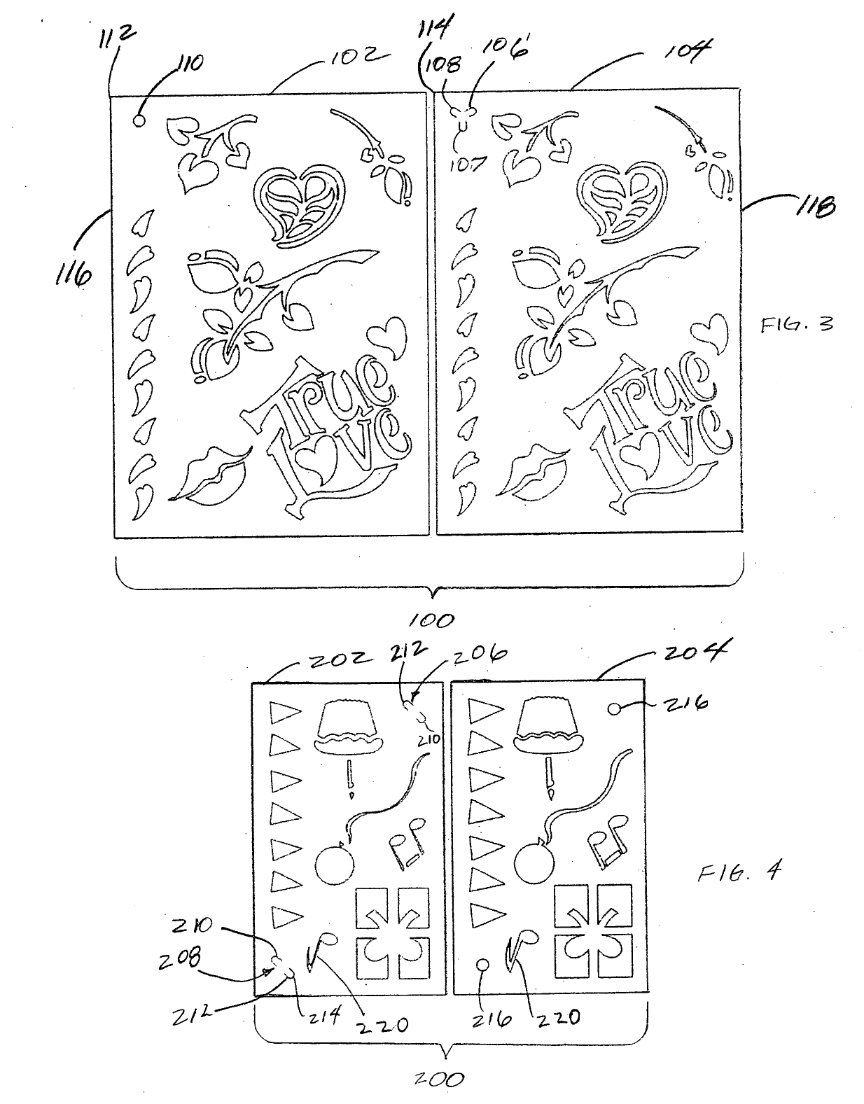

FIG. 2 illustrates the embossing device 20 in assembled form. The guides 44 are defined near the center point 46 of the first element 22. The three guides 44 extend radially from the center point 46 with each guide formed by a U-shaped channel or slot 52 that is formed in the first embossing element 22.

The guides 44 are thus integrally formed with the first embossing element 22. The first and second ends 56 and 58 of the slots form a living hinge 59 therein between such that the guides 44 can flex about the living hinge 59 to be inserted through the aperture 54 of the second embossing element 24. The engagement of the guides with the aperture 54 provides a secure, yet selectively releasable coupling between the first and second embossing members 22 and 24. Moreover, the use of a round aperture 54 allows the two embossing members to be pivotable relative to one another.

In operation, a user bends the guides 44 about the living hinge 59 away from the plane of the first element 22 such that all of the guides 44 may simultaneously fit through the aperture 54 of the second element 24. The first and second elements 22, 24 are then disposed in a parallel, planar abutting relationship and are rotateably joined about the aperture 54 for relative angular movement. A user then inserts a desired media between the first and second elements 22, 24 and uses the alignment notches and tabs to correctly orient the first and second elements 22, 24 such that the media may then be embossed as desired. It is within the teachings of the present invention that the media may be any deformable material, such as, paper, cardboard, plastic, synthetic material, or metal.

It is also contemplated that the first and second elements 22 and 24 could be coupled by an interconnection element comprised of a spot weld that permanently bonds the first and second elements 22 and 24 together at a particular point. This could be accomplished whether the first and second elements 22 and 24 are comprised of metal, plastic or other weldable materials.

Referring now to FIG. 3, there is shown another embodiment of an embossing apparatus, generally indicated at 100 in accordance with the principles of the present invention. The embossing apparatus is shown in its disassembled form comprised of two substantially similar embossing elements 102 and 104 each being generally rectangular in shape. It is noted that while it has been discussed that the designs formed in what would be generally considered the top element 104 may be formed slightly larger than those formed in the bottom element 102 in order to accommodate the engagement of a stylus or embossing tool, it is also contemplated that such design be virtually identical in shape and size in both the first and second embossing elements 102 and 104. By doing so, the embossing elements 102 and 104 could be interconnected and used with either embossing element 102 or 104 being on top.

The embossing elements 102 and 104 are coupled together by tabs 106, 107 and 108 formed in the embossing element 104 and an aperture 110 formed in the embossing element 102. The tabs 106, 107 and 108 can be inserted through the aperture 110 in a manner similar to that previously described with reference to FIG. 1 and FIG. 2. Also, by providing the point of coupling of the two embossing elements 102 and 104 proximate the corners 112 and 114 of the embossing elements 102 and 104, respectively, a larger surface area of each embossing element 102 and 104 is provided thus allowing larger media to be embossed with the two embossing elements 102 and 104 being coupled proximate the corners 112 and 114.

It should be noted, that the coupling of the first and second embossing elements 102 and 104 is provided inside the perimeters or outer edges 116 and 118 thereof.

As further illustrated in FIG. 4, an embossing apparatus, generally indicated at 200 is illustrated. The embossing apparatus 200 has a generally rectangular shape and is comprised of two embossing elements 102 and 104. The embossing element 202 includes a pair of coupling elements 206 and 208 each formed from a pair of tabs 210 and 212. Again, the tabs 210 and 212 are integrally formed from the embossing element, each formed by a U-shaped slot 214. Each pair of tabs 210 and 212 are configured to engage with one of the apertures 216. By providing a pair of coupling elements 206 and 2108 proximate opposite corners of the embossing elements 202 and 204, larger media may be embossed using such embossing elements 202 and 204 with less interference from the coupling elements 206 and 208. For example, if it is desired to emboss a medium with a design, such as the note 220, the coupling element 208 can be released while leaving the coupling element 206 engaged for proper alignment of the two embossing elements 202 and 204. This allows the note 220 to be embossed on a medium at a location from the edge of the medium greater than the distance from the coupling element 208 to the note 220.

As shown in FIGS. 5A, 5B, 6, and 7, various configurations of coupling may be employed using an aperture/tab arrangement in accordance with the principles of the present invention. In each embodiment, each of the various coupling configurations provide coupling of the embossing members at a general single point of attachment. Such a single point of attachment provides for a larger useable area of the embossing device when a medium is inserted between two embossing members. For example, as shown in FIGS. 5A and 5B, a two-pronged arrangement, generally indicated at 250, for coupling a first embossing member 252 to a second embossing member 254. The two prongs 256 and 258 are inserted through the hole or aperture 260 in the embossing member 254. Living hinges 262 and 264 are formed in the two prongs 256 and 258, respectively, proximately along the base of each prong 256 and 258.

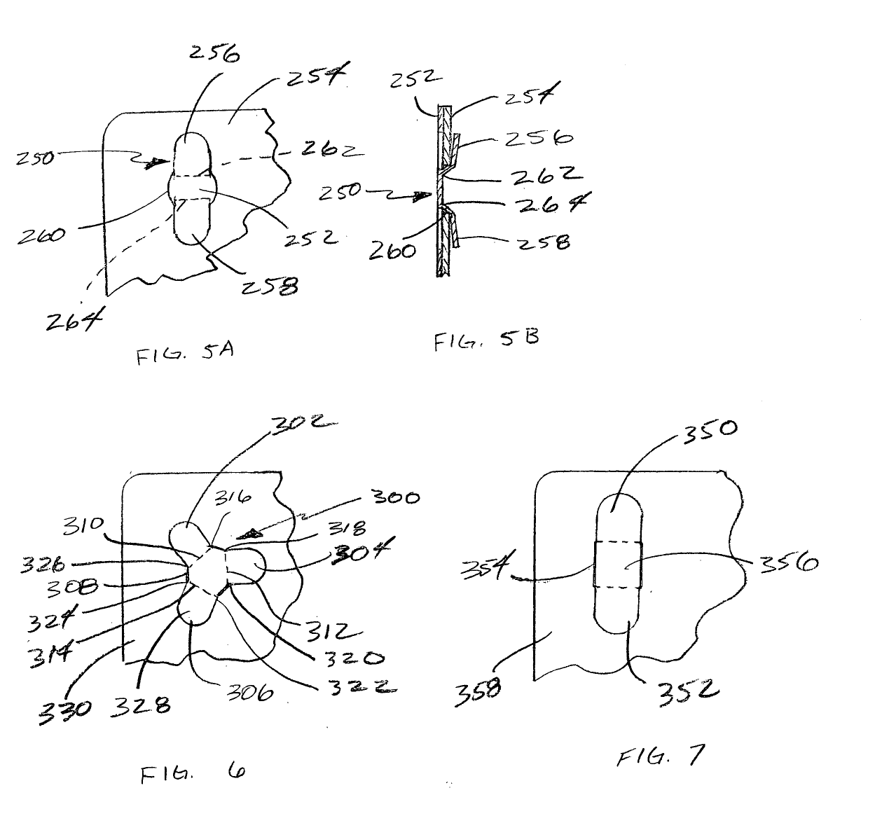

As illustrated in FIGS. 6 and 7, not only do tabs inserted through their respective hole provide a means for coupling two embossing members together, but the engagement of the tabs with a non-circular aperture can be employed to assist in aligning two embossing members. Referring specifically to FIG. 6, a coupling assembly, generally indicated at 300, is comprised of three tabs 302, 304 and 306 that extend through a generally triangularly shaped aperture 308. The base portions 310, 312 and 314 of each tab, 304, 306 and 308, respectively, engage in an abutting manner with the corners 316, 318, 320, 322, 324 and 326 of the aperture 308. This engagement generally prevents or at least limits free rotation of the first and second embossing members 328 and 330. As such, the coupling assembly 300 also helps to properly align the first and second embossing members 328 and 330, respectively.

Likewise, as shown in FIG. 7, a two-tab configuration with tabs 350 and 352 that engage with a rectangular or square aperture 354 couples the first and second embossing members 356 and 358 together while also assisting in aligning the first and second embossing members 356 and 358 relative to one another. As such, it is contemplated within the spirit and scope of the present invention that various numbers of tabs may be employed along with various shapes of apertures in order to attach at least two embossing members together in either a freely rotatable manner or in a manner that limits free rotation of the first and second embossing members relative to each other.

Referring now to FIGS. 8A, 8B, 9A, 9B, 10A and 10B, there are shown various mechanical-type attachment devices that may be employed to attach a first embossing member to a second embossing member in accordance with the principles of the present invention. For example, as shown in FIGS. 8A and 8B, a rivet 400 that is inserted through apertures 402 and 404 of embossing members 406 and 408 is employed to attach the two embossing members together. Because the head 410 and base 412 of the rivet is larger in diameter than the diameters of the apertures 402 and 404, the rivet 400 maintains the two embossing members 406 and 408 in a back-to-back relationship. Also, depending on the fit of the rivet 400 relative to the surfaces of the embossing members 406 and 408, the embossing members 406 and 408 can be allowed to rotate relative to one another about the rivet 400 or the rivet could be attached in a manner in which an interference fit is formed that would prevent relative pivoting of the two embossing members 406 and 408.

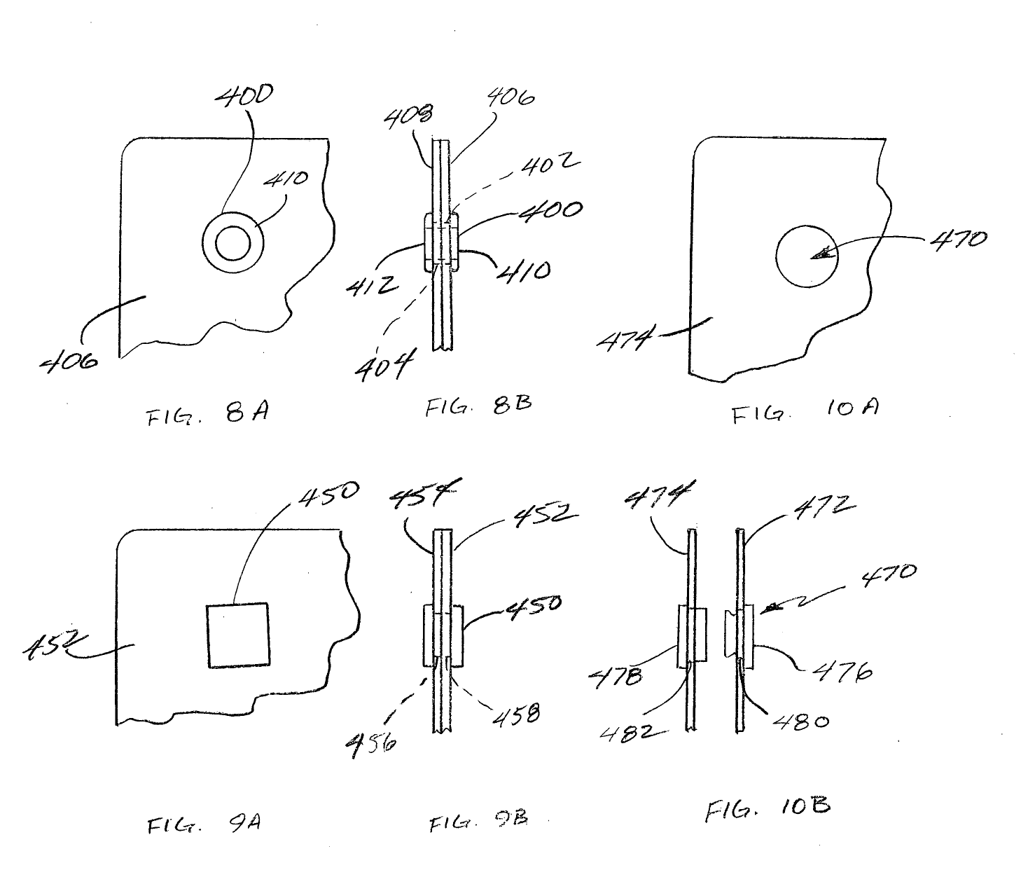

Likewise, as shown in FIGS. 9A and 9B, a coupling device 450 attaches two embossing members 452 and 454 together in an abutting manner. The coupling device 450 engages with square apertures 456 and 458 formed in embossing members 454 and 452, respectively. As with certain other tab/aperture arrangements described herein, the engagement of the coupling device 450 with the aperture prevents relative rotation or pivoting of the first and second embossing members 452 and 454.

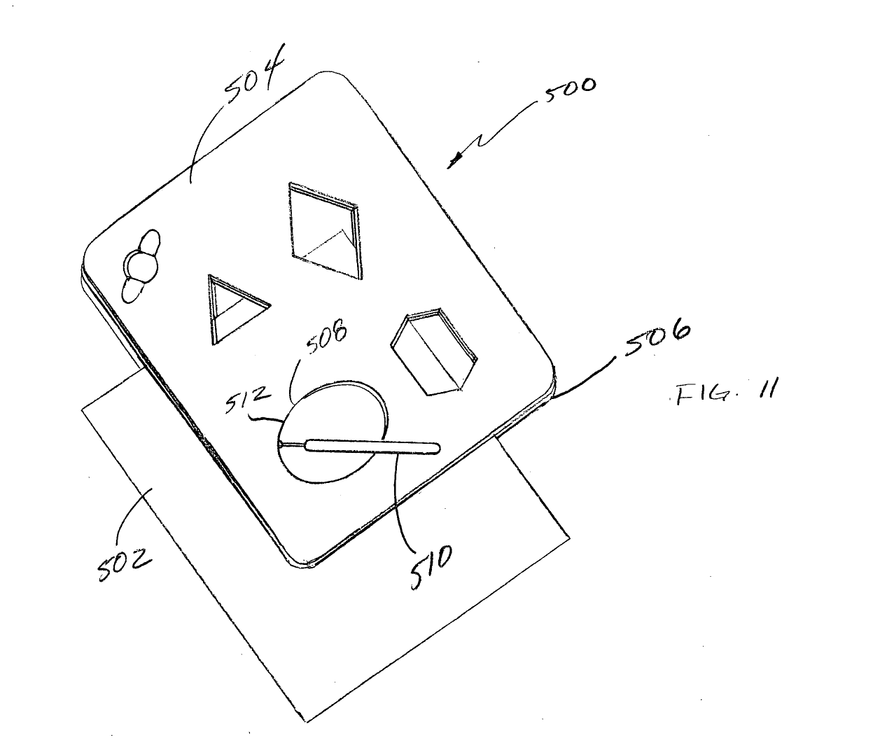

As further shown in FIGS. 10A and 10B, it is further contemplated that a releasable mechanical-type attaching device, generally indicated at 470 may be employed that allows for selective releasability of the first and second embossing members 472 and 474. The attaching device 470 is in the form of a snap with a male portion 476 and a female portion 478, with each portion 476 and 478 inserted through a respective aperture 480 and 482. By fitting the male portion 476 into the female portion 478, the two portions 476 and 478 can be releasably coupled together, thus also coupling the two embossing members 472 and 474 together.

Finally, as illustrated in FIG. 11, an embossing apparatus, generally indicated at 500, is illustrated to show use of the embossing apparatus 500 to emboss a medium, such as a sheet of paper 502. The paper 502 is inserted between the upper and lower embossing members 504 and 506, respectively. The desired design 508 is aligned with the paper 502 at a desired location. An embossing tool 510 is then pressed around the inside surface of the design 508 pressing the paper 502 in a direction toward the lower embossing member 506 and into the design 508 provided in the lower embossing member 506. The thickness of the embossing member 506 will determine the depth of the embossed feature in the paper 510. Thus, the thickness of each embossing member 504 and 506 may vary. For example, the thickness of the upper embossing member 504 should be sufficient to properly guide the embossing tool 510 without the tool 510 slipping over the top edge 512 of the opening defining the design 508. Likewise, the thickness of the bottom embossing member 506 is such that a desired depth of embossing is achieved.

While particular embodiments of the present invention have been shown and described, it will be obvious to those skilled in the art that changes and modifications may be made without departing from the teaching of the invention. The matter set forth in the foregoing description and in the accompanying drawings is offered by way of illustration only and not as limitation. The actual scope of the invention is intended to be defined in the following claims when viewed in their proper perspective based on the prior art.

What is claimed:

1. An embossing apparatus, comprising:
a first embossing element having a first design of a first size and a first interconnection element; and
a second embossing element having a second design of a second larger size, said second design being substantially similar to said first design, and a second interconnection element, wherein the first interconnection element engages the second interconnection element so that said first and second interconnection elements interconnect said first embossing element to said second embossing element to align said first design of said first embossing element relative to said first design of said second embossing element.

2. The embossing apparatus of claim 1, wherein said first and second embossing elements each comprise a flat sheet of material.

3. The embossing apparatus of claim 2, wherein said first and second embossing elements are comprised of an at least partially transparent material.

4. The embossing apparatus of claim 1, wherein said first interconnection element comprises at least one tab integrally formed with said first element and said second interconnection element comprises an aperture formed in said second interconnection element, said at least one tab being inserted through said aperture.

5. The embossing apparatus of claim 1, wherein said first and second interconnection elements comprise a mechanical fastener for adjoining said first and second embossing elements.

6. The embossing apparatus of claim 1, wherein said first and second embossing elements are generally round in configuration and said first and second interconnection elements are located proximate the centers of said first and second embossing elements.

7. The embossing apparatus of claim 1, wherein said first and second embossing elements are generally rectangular in configuration and said first and second interconnection elements are located proximate at least one corner of said first and second embossing elements.

8. An embossing apparatus, comprising:
a first embossing member defining at least one first embossing design therein and including at least one coupling element integrally formed therewith; and
a second embossing member defining at least one second embossing design and further defining at least one aperture for receiving said at least one coupling element therein and for retaining said at least one coupling element thereto.

9. The embossing apparatus of claim 8, wherein said at least one coupling element comprises a plurality of tabs integrally formed with said first embossing member, said plurality of tabs inserted through said aperture for engaging therewith and coupling the first embossing element to the second embossing element.

10. The embossing apparatus of claim 8, wherein said first and second embossing elements are comprised of flat sheets of material.

11. The embossing apparatus of claim 8, wherein said first and second embossing elements are circular in shape and wherein said at least one coupling element is located proximate the center of said first embossing element.

12. The embossing apparatus of claim 8, wherein said at least one coupling element comprises a plurality of coupling elements that can each independently couple said first embossing element to said second embossing element.

13. The embossing apparatus of claim 8, wherein said first and second embossing elements are comprised of an at least partially transparent material.

14. The embossing apparatus of claim 1, wherein said at least one first embossing design is smaller in size than said at least one second embossing design.

15. An embossing apparatus, comprising:
a first embossing member defining at least one first embossing design therein; and
a second embossing member defining at least one second embossing design therein; and
at least one coupling element coupling said first embossing member to said second embossing member at a discrete point.

16. The embossing apparatus of claim 15, wherein said at least one coupling element comprises a mechanical fastener.

17. The embossing apparatus of claim 15, wherein said at least one coupling element comprises a plurality of tabs integrally formed in said first embossing member and an aperture defined by said second embossing member, said plurality of tabs inserted through said aperture for engaging therewith and coupling the first embossing member to the second embossing member.

18. The embossing apparatus of claim 15, wherein said coupling element comprises a weld.

19. The embossing apparatus of claim 15, wherein said first and second embossing members are comprised of flat sheets of material.

20. The embossing apparatus of claim 15, wherein said first and second embossing members are circular in shape and wherein said at least one coupling element is located proximate the center of said first and second embossing members.

21. The embossing apparatus of claim 15, wherein said at least one coupling element comprises a plurality of coupling elements that can each independently couple said first embossing member to said second embossing member.

22. The embossing apparatus of claim 15, wherein said first and second embossing members are comprised of an at least partially transparent material.

23. The embossing apparatus of claim 15, wherein said at least one first embossing design is smaller in size than said at least one second embossing design.
